(19) United States
(12) Patent Application Publication
(10) Pub. No.: US 2009/0248640 A1
(43) Pub. Date: Oct. 1, 2009

(54) DEVICE FOR INDEXING ALL WORDS IN BOOKS

(76) Inventor: Agmon David PORAT, Ganei Yehuda (IL)

Correspondence Address: EDWARD LANGER;c/o SHIBOLETH YISRAELI ROBERTS ZISMAN & CO., 1 PENN PLAZA-SUITE 2527, NEW YORK, NY, 10119, US

(21) Appl. No.: 12/400,038

(22) Filed: Mar. 9, 2009

Related U.S. Application Data
(60) Provisional application No. 61/040,730, filed on Mar. 31, 2008.

(51) Int. Cl. G06F 17/30

(52) U.S. Cl. 707/3; 707/E17.014

(57) ABSTRACT

A search engine and a display system are combined together and utilized in a book or document; and, used to carry out a digital search in the book or document, to retrieve information from any place in the book. It comprises a combination of a digital search engine, memory and a user interface that includes a display system and a keyboard, together with the book. This combination allows the user to enter a specific word or phrase and see the exact location of the specific word or phrase in the book.

### CROSS-REFERENCE TO RELATED APPLICATIONS

Applicant is the owner of U.S. Provisional application 61/040,730, filed 31 Mar. 2008, and hereby claims priority pursuant to 35 U.S.C. 120 and 37 C.F.R. 1.78.

### FIELD OF THE INVENTION

The present invention relates to the book publishing and literature industry and, more particularly, to computer search engines that may be incorporated into books.

### BACKGROUND OF THE INVENTION

Through the use of the computer and Internet, searching in an electronic file is familiar, easy and commonplace; on the other hand, it is not easy to search in a book. In particular, it is difficult to find the required information or the relevant pages in, for example, technical, research, professional and/or educational books. Books are typically searched to find information they contain by using a printed table of contents or index included within the published book, and then manually searching all data elements in the book. Mostly, the index is not simplified for searching purposes and contains only selected words from the total text in the book. If one needs to look up something in the book, the indexing mechanism in the back of the book may not be very helpful. Some books today can be obtained in the form of a digital copy which can be viewed on a computer and thus allow a detailed search using existing software programs either on the computer or using a PDA, but this search option is not available to those who study or read from the physical book itself.

### DESCRIPTION OF THE PRIOR ART

Today, in addition to existing digital copies of books for reading on computer screens, PDAs and even electronic paper that is available to read books digitally, the state of the art includes RF ID tags for books to be catalogued or to use in order to find books for example on Library shelves. KR20020062828 describes a data management system that stores a directory and data such as a source, contents, storage data or a lending status to enable a user to perform a search or retrieval, or a lending operation by using an RF ID tag, independent of the actual hard copy book.

GB2397273 describes printed material, including pictures, text, video or images which have RFID or optical tags that are embedded on to paper prior to printing to allow reader to view the files tagged or retrieve data not included in the book, and view on a PDA screen.

Iggulden (U.S. Pat. No. 6,269,238) describes a printed book with electronically stored data, providing the reader with visual cues in the vicinity of text having associated electronically stored data.

Embedded tags as described in Back (U.S. Pat. No. 6,655,586) are used to identify a particular page that a reader is viewing, to correlate the page to information on a stored memory and activate dynamic content or effects.

Mao (U.S. Pat. No. 6,546,385), however, describes a compressed complete index, that can stored on the web or be printed in a computer readable format such as a 2D bar code as part of a hardcopy book. The user of the computer extracts information from the index and uses it to search the book via this barcode. Again a computer device is needed in order to read the indexed data and carry out the detailed search.

Tien (USA Publication 2008/0016133) describes a method in integrating an electronic device in a book cover such as a calculator or MP3 player. This invention is not for a searching words in the a hard copy book nor has the ability to send information on the readers or supply additional information on the book, a search engine is required and the ability to insert information to the device by the publisher or the user is needed.

None of the prior art allows for an electronic search of the entire contents of the book to enable the user to identify the location of any word or phrase in the book on a display included in the book.

In addition, feedback on the book from readers is obtainable only in the form of sales figures but there is no real data about the actual number of readers and their preferences, interests and habits.

There is a strong need to create a physical book with a digital search engine device to enable the end user to enjoy a fast, user friendly and accurate search when reading or studying from a book, without the need to upload a digital version of the book, even assuming such a version exists. There is also a need for a tool to provide more accurate statistics on readers and their preferences to the publishers and authors.

### SUMMARY OF THE INVENTION

These and other objects of the invention are obtained by an electronic search engine embedded in the physical book.

The present invention will enable the reader to search all words in the book and not just the selected words from the index printed in the book, as is common today. There will also no longer be a need for the publisher to choose which words or phrases should be inserted into the specially compiled index commonly printed in the rear of books today, as all words could be searched by the electronic search engine. Publishers could even dispense altogether with a printed index in view of the electronic search engine.

In a preferred embodiment, the invention consists of a search engine and a display system for a digital search in a physical book or document with the capability to retrieve information from any place in the book or additional data that is not in the book. It comprises a combination of a digital search engine, memory, Central Processing Unit (CPU) and a user interface. The interface can include a display system and a keyboard, or a voice recognition unit as part of a book. This enables the user to type or say a specific word or phrase and the display system would show the results on the display panel on the book. The invention can also enable the user to insert digital data into the book.

By means of this invention the publisher can also retrieve relevant sales data and reading preferences from the reader by wireless transfer of such data enabling transfer of the information to the web or to a wireless memory device such as a removable memory card.

### BRIEF DESCRIPTION OF THE DRAWINGS

FIG. 1 is a perspective view of a book with the embedded search engine;

FIG. 2 is an alternate embodiment of a book with an external search engine;

FIG. 3 is a perspective view of the book cover with the search engine of the instant invention;

FIG. 4 is a block diagram, showing the elements of the search device;

FIG. 5 is a block diagram, showing the elements of an alternate embodiment of the search device;

FIG. 6 is an operational flowchart showing the stages of the search; and

FIGS. 7 and 8 outline a possible sequence of events to search for a word or phrase in the book using the search engine.

### DETAILED DESCRIPTION OF THE INVENTION

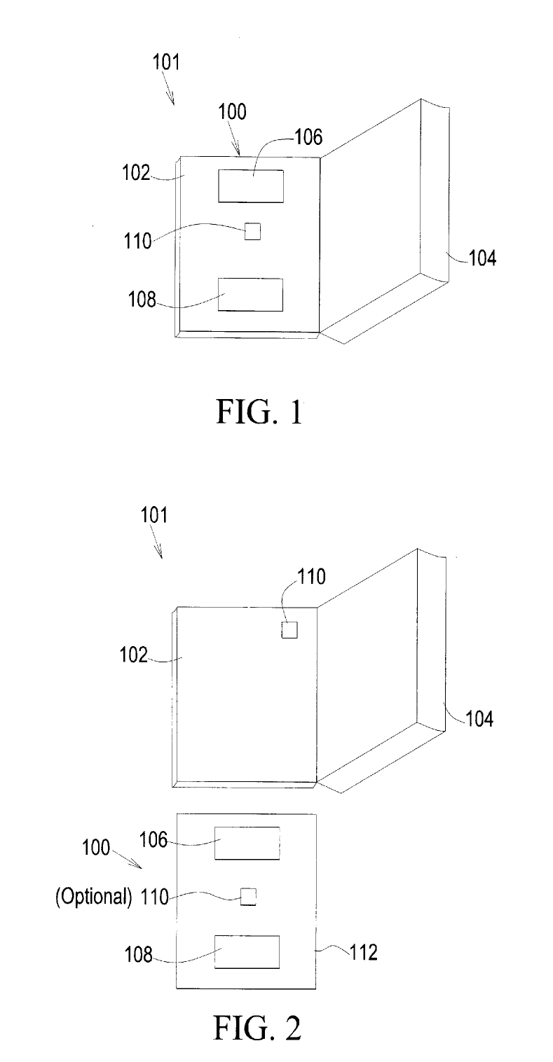

The basic format of the search engine device 100 of the present invention is shown in FIGS. 1-3 herein. Any physical book 101 may be used with the present invention. As shown a standard book has a front cover 102 which may typically be made of stiffer, sturdier stock, followed by a plurality of paper pages 104.

It may be appreciated that the present invention contemplates use on any hard copy book, i.e., hard cover or paperback. For simplicity in describing the invention, reference is made to physical books, but it needs to be appreciated that the invention may also be implemented in hard copy and paperback books.

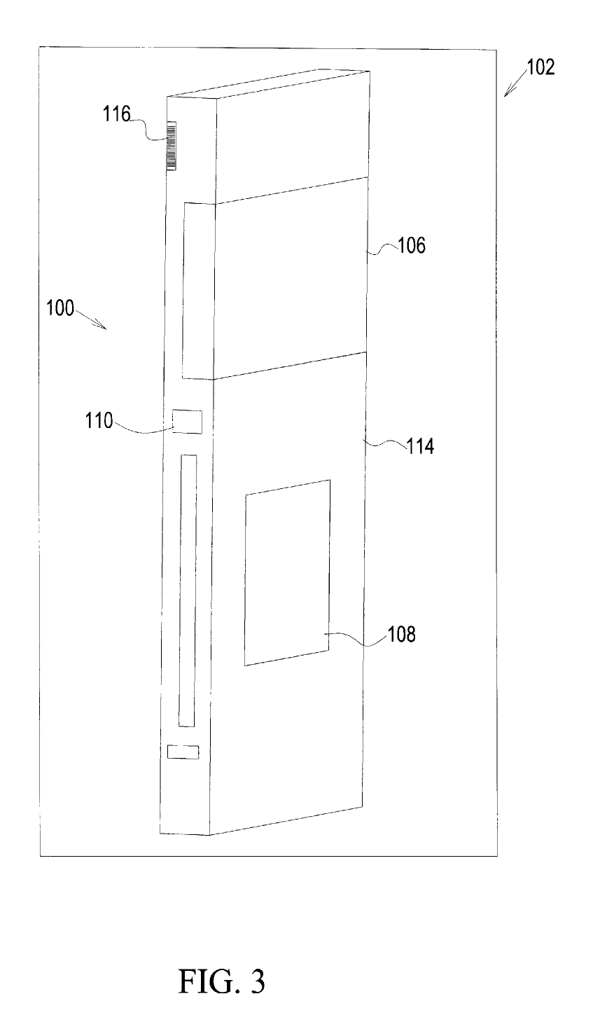

The search engine device 100 can be attached to the book in any suitable manner. In the preferred embodiment of FIGS. 1 and 3, it is shown as embedded in the cover 102 of the book 101. FIG. 2 shows an alternate embodiment where the search device is positioned in juxtaposition to the book, but is not actually embedded or affixed to the book.

Three basic elements constitute the inventive search engine 100—display screen 106, input interface 108, and searchable memory 110. Reference is made to FIGS. 1, 2 and 3 which show these elements. First, there is a display screen of some type. Any known screen can be used, so long as it is sturdy enough to not be damaged by the pages of the book and will be able to maintain sufficient visibility for the user to see it. One preferred type of user display screen is a thin film transistor liquid crystal display (TFT-LCD), which is a variant of the well known liquid crystal display (LCD). A standard LCD display may also be used.

A screen such as those used for a calculator would be sufficient. It does, however, have to be thin and preferably an integral part of the book's binding.

The input interface 108 preferably is a keyboard. One especially suitable type would be membrane keyboards, which are usually flat. They are most often found on appliances like microwave ovens or photocopiers. Such a design is well-suited for this application, because it is less likely to be accidently “pushed,” then the physical buttons of a standard keyboard. It will also lie flat and not disturb the pages. A membrane keyboard is a computer keyboard whose “keys” are not separate, moving parts, as with the majority of other keyboards, but rather are pressure pads that have only outlines and symbols printed on a flat surface.

The embedded search engine device 100 on the book cover is made of a sufficiently thick PC-type board, which is strategically adapted to support an electronic device. A cutout or pocket in the book cover board receives the search engine device 100, and it is securely bolstered therein. The PC-type board may be completely covered by an elastic skin 114, except in an opening where the device displays visual information. The PC-type board also includes a microphone or a keypad 108, labeled with various characters and symbols, which can be pressed to initiate the processing of preprogrammed functions by the search device. See FIGS. 1-3.

In the alternate embodiment of FIG. 2, where the search engine is not mounted in the book, it may be desirable to use a foldable keyboard. Such keyboards are designed out of flexible materials that can roll up in a moderately tight bundle. Normally the external materials are either silicone or polyurethane. Alternatively, a laser projection device approximately the size of a computer mouse projects the outline of keyboard keys onto a flat surface, such as a table or desk. This type of keyboard is portable and would be particularly well-suited for use with a book.

The type of keyboard is not of relevance. What is important is the concept that there would be a user interface that would allow the reader to type in to the search engine device 100 a word that he/she is looking for. This typing can be on a keyboard or even a keyboard projected on a touch screen.

The third element is the searchable memory 110. Basically, this is a computer chip onto which the entire contents of the book have been downloaded, so that the contents can be searched using standard search engine techniques. If desired, additional information can also be loaded on the chip and made searchable. It may be embedded in the front book cover, as shown in FIGS. 1 and 3, or any other suitable location in the book 101, like the spine. In FIG. 2, an alternate embodiment is shown where it is not embedded in the book, but is in close juxtaposition.

In the present invention, the term “computer chip” represents the processor that would identify the location of the word or phrase in the book. It would also have a memory containing the book's words. The amount of memory that a 3000 page book with 500 words per page would use is only about 1.5 MB, as the memory need only save the words and not the style settings or pictures. For most of the books, it is much less than that and is only few hundred KB. There are many types of search engines that are available in the market today and therefore there are several alternatives which would prove suitable.

In the alternate embodiment of FIG. 2, the search engine device 100 is external to the book 101, but in close juxtaposition to it, so that the search engine device 100 may easily be used by the reader. The display 106, input interface 108 and optionally, the searchable memory 110, are all combined in a single unitary platform 112.

If desired, a wireless memory card reader providing a searchable memory can be used, as described in U.S. Pat. No. 6,522,552 to Lee, the disclosure of which is incorporated herein by way of reference. This arrangement provides a wireless transmission driver enabling wireless transmission of memory contents. Alternatively, a port 116 may be provided to input the information, such as a USB port to write data containing the book contents into the memory 110 associated with the book 101. Alternatively, wireless data transfer such as an RFID or Bluetooth or Wi-Fi may be utilized. The memory 110 may also constitute a disc-on-key type.

The search engine device 100 can be separated from the book 101, while keeping the memory 110 on a wireless memory card attached to the book 101. This separated search engine device 100 would read the index from the wireless memory card, as described above, using wireless data transfer such as an RFID or Bluetooth or Wi-Fi technology.

As explained herein, the search device 100 can be attached to the book 101; or, it may be embedded in the cover of the book 101, so that it can read the full index contained in the memory from a remote device. The invention could include a memory with or without a RFID to insert the memory or for reading the index, with or without a USB port to insert a memory key, or processing chip for reading the index from the memory, or the device can obtain the index downloaded from the internet. The interface for use by the reader could be a keyboard and a display screen, similar to the common electronic calculator with LCD display.

The power source could be a small battery, a solar panel, or thermal power. Voice recognition could be added to the memory device.

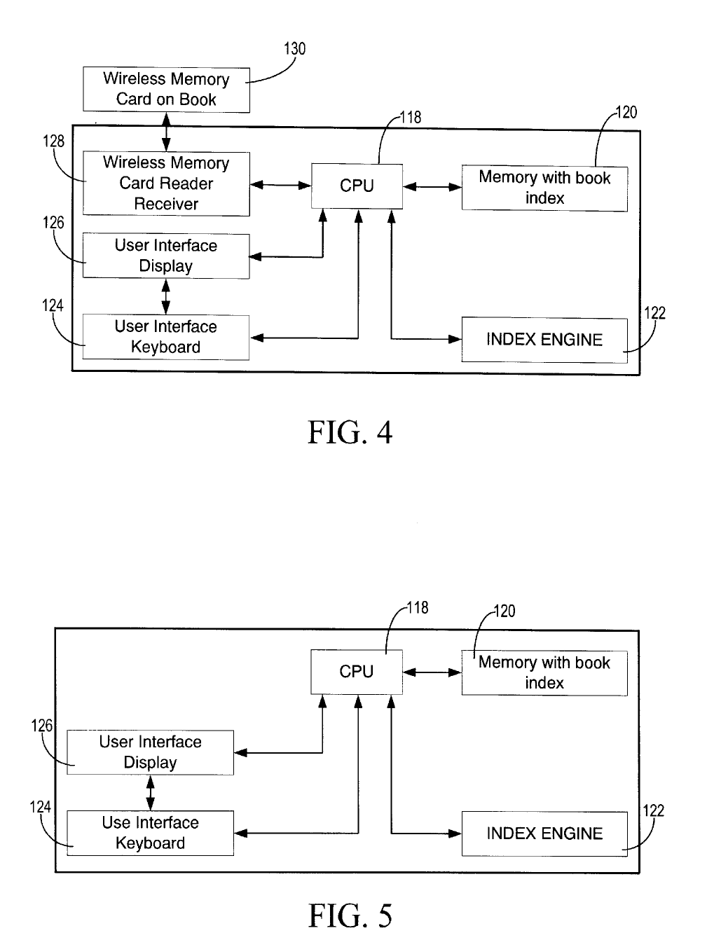

As seen in FIGS. 4 and 5, the device consists of a CPU or processor 118 that receives the memory with the book index 120 and uses a search engine program 122 to offer a result. The data needed for the search is inputted via the keyboard interface 124, and results are seen on display interface 126. The index can also be obtained by the processor from a wireless memory card reader 128 that receives the data from a wireless memory card on the book 130. In one embodiment (FIG. 4) only the index is on a wireless memory card on the book and the search mechanism is separated; and, in another embodiment (FIG. 5), the search mechanism is part of the book.

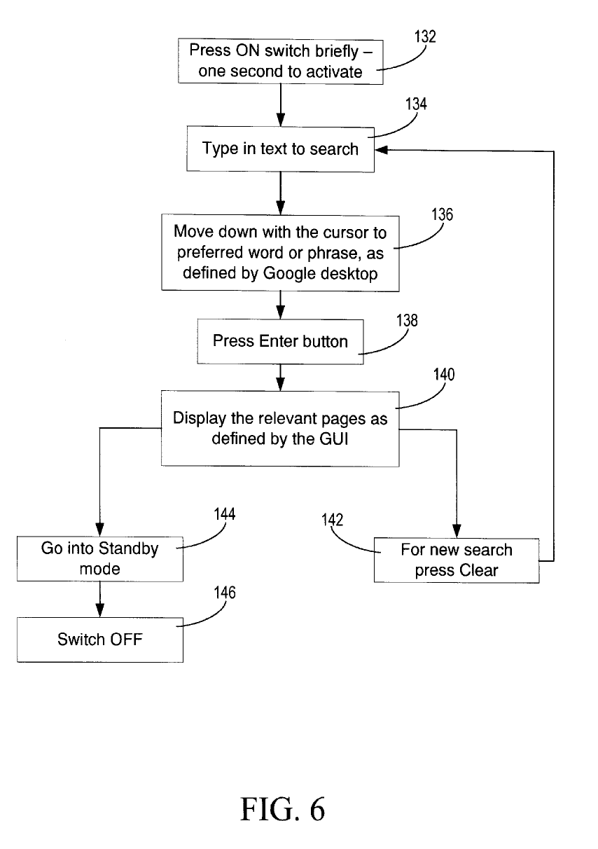

The basic operation of the device is illustrated in FIG. 6, which is an operational flowchart, showing the stages of the search. After activating the device (132), the user enters the word(s) to be searched (134). The search engine returns the found listings and shows them on the display. These selections are reviewed by the user; the user moves the cursor to the desired selection (136) and the user then selects the desired one (138) by hitting the enter button. The entire page may be viewed on the screen or the user may simply turn the relevant page in the book (140). Thereafter, the device can be cleared (142) and a new search initiated (134). Alternatively, the user may go to standby mode (144) if he has no further selections, and eventually the device is turned off (146).

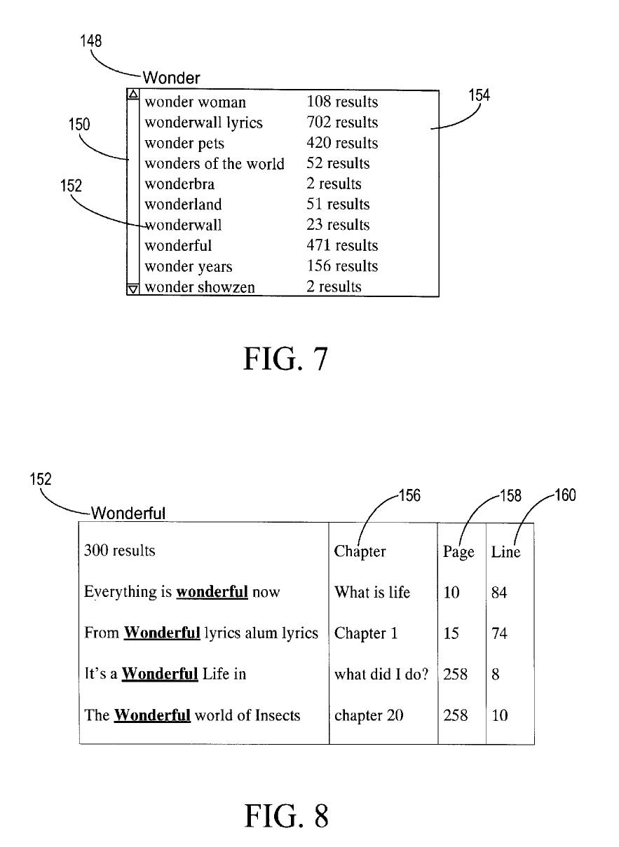

FIGS. 7 and 8 illustrate a possible sequence of events to search for a word or phrase in the book. As shown in FIG. 7, when the search word is entered, the display 148, which may preferably include a scroll bar 150, can show a list of words or phrases 152 from which to choose together with the results, and a list 154 of the number of times that word or phrase appears in the book. Upon pressing the required result in the list 152 displayed, as shown in FIG. 8, the search engine displays the results and identifies the sentence(s), as found in the book. Each chapter 156, page 158 and line 160 for that the particular word (or phrase) as found in the book may be displayed.

The method and device for carrying out a search in the content of a book or document comprises a display for displaying information to a user; a user input interface for accepting input from the user; a CPU to process the stored index information, a search engine program that offers results of the exact locations of the searched for data inputted by the user, all embedded in the book or document or displayed on a separate remote device.

This invention may be described as an electronic device for searching for and locating data in a physical book, as an integral part of the book. It includes: a searchable electronic memory containing the entire text of the book; a user display; and a user input interface. By means of the user input interface, a user may input data to be located and the location of said data in said book is shown on said user display. Thus, it displays searched content directly on the book.

The present invention has many features and advantages not currently available in the market. It may be appreciated that the memory can be on a wireless memory card on the book and the device would be separated from the book and allow a search to be done according to the stored contents in the wireless memory card on the book. Alternatively, the memory can include additional information that is not in the book. The device can be part of the book or on any side of the book's cover or as one of the inner papers. If desired, the search results can give additional information that is not in the book. The search query and the results can be submitted by voice or by visual. To allow additional information that is not in the book's memory, the device can be connected to the Internet. Further, the device can be connected to the Internet to send information on the book's searches to the publisher.

The invention is described in detail with reference to a particular embodiment, but it should be understood that various other modifications can be effected and still be within the spirit and scope of the invention.

I claim:

1. An electronic device for searching for and locating data in a physical book, comprising:
a searchable electronic memory containing the entire text of the book;
a user display; and
a user input interface,
wherein by use of said user input interface a user may input data to be located and the location of said data in said book is shown on said user display.

2. The device of claim 1 wherein said device is embedded in said book.

3. The device of claim 1 wherein said user input interface is a keyboard.

4. The device of claim 3, wherein the user input interface is a membrane keyboard.

5. The device of claim 1 wherein said user display is a LCD screen.

6. The device of claim 1, wherein a cover of said physical book includes a pocket in which said searchable electronic memory, said user display and said user input interface are positioned.

7. The device of claim 6 further comprising an elastic skin applied on said cover over said searchable electronic memory, said user display and said user input interface.

8. The device of claim 1 wherein said searchable electronic memory is a wireless memory card containing searchable memory.

9. The device of claim 1, wherein said searchable electronic memory, said user display and said user input interface are in close juxtaposition to said physical book.
